(19) United States
(12) Patent Application Publication
(10) Pub. No.: US 2009/0276133 A1
(43) Pub. Date: Nov. 5, 2009

(54) AIRCRAFT BRAKE CONTROL SYSTEM AND METHOD

(75) Inventors: William P. May, Tipp City, OH (US); Richard P. Metzger, JR., Troy, OH (US)

Correspondence Address: SNELL & WILMER L.L.P. (GOODRICH), ONE ARIZONA CENTER, 400 E. VAN BUREN STREET, PHOENIX, AZ, 85004-2202, US

(73) Assignee: GOODRICH CORPORATION, Charlotte, NC (US)

(21) Appl. No.: 12/434,889

(22) Filed: May 4, 2009

Related U.S. Application Data
(60) Provisional application No. 61/050,421, filed on May 5, 2008.

(51) Int. Cl. G06F 17/00; F16D 66/00

(52) U.S. Cl. 701/75; 188/1.11 E

(57) ABSTRACT

A method includes receiving an input brake command that indicates a desired amount of braking for a vehicle. A brake control signal is then derived from the input brake command to facilitate applying a braking force to a wheel of the vehicle, and the braking force facilitates achieving the desired amount of braking for the vehicle. The method further comprises determining that data from a sensor associated with the wheel is unavailable, and then modifying the brake control signal in response to determining that the data is unavailable. The modification may be based on sensor data or controller output associated with a second wheel where data is available. Such modification facilitates the desired amount of braking for the vehicle.

### CROSS-REFERENCE TO RELATED APPLICATIONS

This application claims priority to U.S. Provisional Ser. No. 61/050,421 filed on May 5, 2008, entitled Aircraft Brake Control System and Method, which is hereby incorporated by reference.

### FIELD OF INVENTION

This invention generally relates to brake systems for vehicles, and more particularly, to an electromechanical braking system and method for use in stopping an aircraft.

### BACKGROUND OF THE INVENTION

Various types of braking systems are known. For example, hydraulic, pneumatic and electromechanical braking systems have been developed for different applications.

An aircraft often presents a unique set of operational and safety issues with respect to braking systems. As an example, uncommanded braking due to failure can be catastrophic to an aircraft during takeoff. On the other hand, it is similarly desirable to have virtually fail-proof braking available when needed (e.g., during landing).

In order to address such issues, various levels of redundancy and antiskid protection have been introduced into aircraft brake control architectures. In the case of electromechanical braking systems, for example, redundant power sources, brake system controllers, and electromechanical actuator controllers, have been utilized in order to provide satisfactory braking even in the event of a system failure.

Antiskid control generally relies on wheel speed sensors that monitor the rotational speed of each wheel. To guard against the loss of wheel speed information from one or more of the wheel speed sensors, conventional approaches have used wheel speed sensors that have at least two channels or other independent signal paths from the wheel speed sensors to brake control units that effectuate antiskid control of the braking operation. However, this approach increases cost and weight, and does not adequately protect against common mode failures that cause the loss of both signal paths from a wheel speed sensor.

Accordingly, a need exists for improved systems and methods for protecting against and addressing braking failure and/or signal loss from wheel sensors, to facilitate the braking of a vehicle.

### SUMMARY OF THE INVENTION

Embodiments of the disclosed systems and methods are directed to techniques for mitigating effects due to the loss of sensor information from a wheel to facilitate the braking of the vehicle.

A method according to an embodiment includes receiving an input brake command that indicates a desired amount of braking for a vehicle. A brake control signal is then derived from the input brake command to facilitate applying a braking force to a wheel of the vehicle, and the braking force facilitates achieving the desired amount of braking for the vehicle. The method further comprises determining whether data from a sensor associated with the wheel is unavailable, and then modifying the brake control signal to that wheel in response to a determination that the data is unavailable. Such modification facilitates the desired amount of braking for the vehicle.

In various embodiments, the input brake command may be associated with an amount of depression of a brake pedal in the vehicle, or it may be associated with a command from an autobrake switch in the vehicle.

In accordance with various embodiments, a brake control unit (BCU) may instruct an electromechanical brake actuator (EBA) to apply the braking force to the wheel. The BCU instructs the EBA to transmit the brake control signal to an electromechanical actuator controller (EMAC), and the EMAC converts the brake control signal into a drive signal specific to the EBA to facilitate applying the braking force to the wheel. In various embodiments, the BCU may determine that the data from a sensor is unavailable in response to the EBA applying the braking force to the wheel. The sensor associated with the wheel may be a wheel speed sensor, and a sensed speed of the wheel may indicate a skid condition of the wheel.

According to an embodiment, modifying the brake control signal includes indicating a reduced braking force to the EBA to facilitate avoiding a skid condition of the wheel in response to the data from the wheel speed sensor being unavailable. In various embodiments, the reduced braking force may be a percentage of the braking force between approximately 20 percent and approximately 80 percent of the braking force.

The BCU may be configured to derive a second brake control signal from the input brake command to facilitate applying a second braking force to a second wheel of the vehicle in accordance with various embodiments. A first brake control signal is associated with a first wheel of the vehicle and may be configured to facilitate applying a first braking force to the first wheel. A first sensor may be configured to provide first data associated with the first wheel. The first braking force and the second braking force may together facilitate achieving the desired amount of braking for the vehicle.

In an embodiment, the BCU may further receive second data from a second sensor associated with the second wheel. The second braking force may be reduced to a modified second braking force in response to the second data indicating that the second wheel is skidding. Further, the first braking force may be reduced in response to reducing the second braking force, and the first braking force may be reduced to be substantially the same as the modified second braking force.

In an embodiment, the second data may be substituted for the first data in response to the first data being unavailable, and the second data may be used to determine the first brake control signal. In various embodiments, the second data may be used to generate the second brake control signal, and modifying the first brake control signal may include replacing the first brake control signal with the second brake control signal in response to the first data from the first sensor being unavailable. In an embodiment, modifying the brake control signal may include periodically pulsing the braking force to facilitate avoiding a skid condition of the wheel.

### BRIEF DESCRIPTION OF THE DRAWINGS

FIG. 1 is a schematic block diagram of an aircraft brake control architecture for an aircraft having four braked wheels in accordance with an embodiment;

FIG. 2 is graph showing brake pressure/force versus time overlaid with a graph of wheel speed information versus time for a wheel with a functional wheel speed sensor and data path to a controller that performs antiskid control functions in accordance with an embodiment;

FIG. 3 is graph showing brake pressure/force versus time overlaid with a graph of wheel speed information versus time for a method of compensating for loss of wheel speed sensor data in accordance with an embodiment;

FIG. 4 is graph showing brake pressure/force versus time overlaid with a graph of wheel speed information versus time for a second method of compensating for loss of wheel speed sensor data in accordance with an embodiment; and

FIG. 5 is graph showing brake pressure/force versus time overlaid with a graph of wheel speed information versus time for a third method of compensating for loss of wheel speed sensor data in accordance with an embodiment.

### DETAILED DESCRIPTION

The detailed description of various embodiments herein makes reference to the accompanying drawing figures, which show various embodiments and implementations thereof by way of illustration and its best mode, and not of limitation. While these embodiments are described in sufficient detail to enable those skilled in the art to practice the embodiments, it should be understood that other embodiments may be realized and that logical, electrical, and mechanical changes may be made without departing from the spirit and scope of the invention. Furthermore, any reference to singular includes plural embodiments, and any reference to more than one component or step may include a singular embodiment or step.

Also, any reference to attached, fixed, connected or the like may include permanent, removable, temporary, partial, full and/or any other possible attachment option. Additionally, any reference to without contact (or similar phrases) may also include reduced contact or minimal contact. Finally, though the various embodiments discussed herein may be carried out in the context of an aircraft, it should be understood that systems and methods disclosed herein may be incorporated into anything needing a brake or having a wheel, or into any vehicle such as, for example, an aircraft, a train, a bus, an automobile and the like

Various embodiments of the disclosed system and method will now be described with reference to the appended figures, in which like reference labels are used to refer to like components throughout. The appended figures include graphs and it will be appreciated that the graphs are not necessarily to scale. Also, the units of the vertical axes are generic units for pressure/force and speed, respectively. Therefore, the numbering of the vertical axes is for descriptive purposes only.

In accordance with various embodiments, a braking system for a vehicle is configured to provide a desired amount of braking to the vehicle, for example, by providing a braking pressure/force to wheels associated with the vehicle. The braking system may provide the desired amount of braking, for example, in a situation where a wheel of the vehicle may be experiencing a skid, and/or where data from the skidding wheel may be inaccurate and/or unavailable. It should be understood that the “unavailable” data includes data that is inaccurate, incomplete, faulty and the like.

To facilitate controlling a skid of a wheel, the vehicle may use data associated with another wheel of the vehicle. For example, a brake control unit may use speed data from one or more wheels to determine an amount of braking force to apply to the wheel where data is unavailable. Further, the brake control unit may determine a brake control signal associated with the wheel where data is available, and then use that brake control signal to control the braking of the wheel where the data is not available. It should be understood that systems according to various embodiments disclosed herein may be incorporated into anything needing a brake or having a wheel, or into any vehicle such as, for example, an aircraft, a train, a bus, an automobile and the like. It should further be understood that the braking systems disclosed herein may be electric, hydraulic, pneumatic or any other type of braking system or combination thereof.

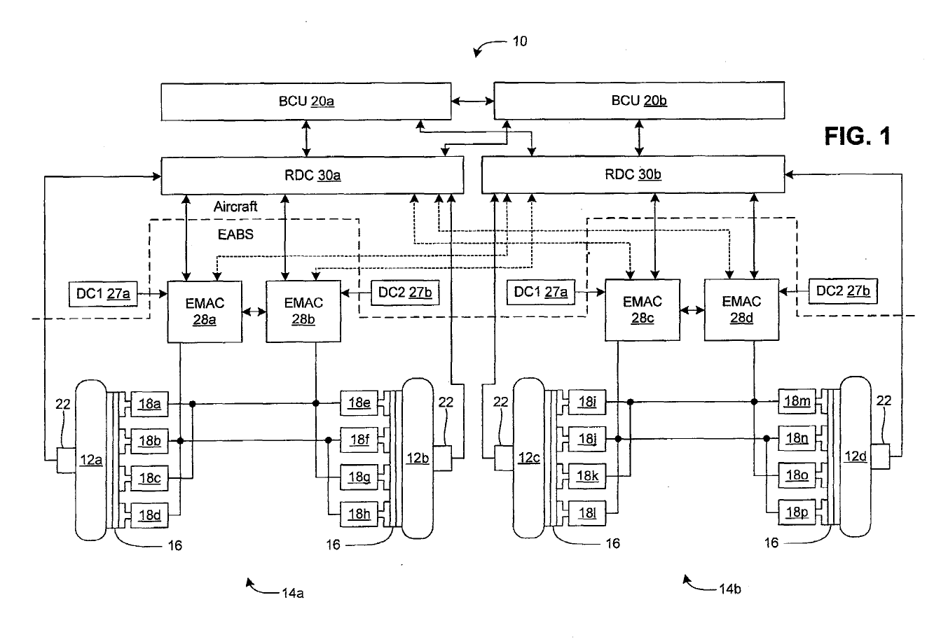

In various embodiments, a braking system is configured to provide the desired amount of braking for the vehicle. For example, with reference to FIG. 1, an embodiment of a braking system 10 for an aircraft is illustrated. The braking system 10 is shown as providing braking with respect to four wheels 12, of which two wheels 12a and 12b are mounted to a left landing gear truck 14a of an aircraft, and two wheels 12c and 12d are mounted to a right landing gear truck 14b of the aircraft. Each wheel 12 has a brake stack assembly 16. Braking force may be applied to the brake stack assembly 16 using electromechanical brake actuators (EBAs) 18. In an embodiment as illustrated in FIG. 1, each wheel 12 is associated with four EBAs 18. Further, a first wheel 12a is associated with EBAs 18a-18d, a second wheel 12b is associated with EBAs 18e-18h, a third wheel 12c is associated with EBAs 18i-18l, and a fourth wheel 12d is associated with EBAs 18m-18p.

It will be appreciated that various embodiments of the disclosed braking system 10 may be extended to aircraft that include any number of wheels 12, any number of landing gear trucks 14, any number of axles per truck, and/or any number of EBAs 18.

Various embodiments of the braking system 10 include an upper level controller, or brake control unit (BCU) 20, for providing overall control of the braking system 10. In an embodiment as illustrated in FIG. 1, two BCUs 20a, 20b are present so as to provide redundancy to the braking system 10.

In accordance with various embodiments, the BCUs 20 may receive an input brake command indicative of a desired amount of braking. For example, brake pedals within the cockpit of the aircraft may be depressed to indicate a desired amount of braking, or an autobrake switch may generate the input brake command. The input brake command is then derived from the distance the brake pedals are depressed and/or from the autobrake selection. In response to the input brake command, the BCUs 20 derive an output command signal in the form of a brake control signal or multiple brake control signals. Collectively, the brake control signals are intended to effectuate the desired amount of braking in relation to the input brake command. Where deceleration and/or antiskid control occurs, data from sensors 22 associated with each wheel 12 and/or each EBA 18 may be used to effectuate the desired amount of braking in conjunction with the input brake command. The sensors 22 may include, for example, a brake temperature monitoring system (BTMS), a tire pressure monitoring system (TPMS), a wheel speed sensor (WSS), an applied torque sensor (ATS), a wear pin monitoring system (WPMS), a wheel & gear vibration monitoring system (WGVMS), a force/pressure sensor (e.g., a load cell), etc. The force/pressure sensor may form part of the EBA 18.

The output of the BCUs 20, in various embodiments, may be in the form of output command signals that are configured to indicate a brake clamp force that is called for by the input brake command. These signals may be input to one or more electromechanical actuator controllers (EMACs) 28 that convert the command signals from the BCU into individual drive signals for the individual EBAs 18. Drivers within the EMACs 28 convert the brake control signals into drive signals that are respectively applied to the EBAs 18. The BCUs 20 may further be configured to communicate directly with the EBAs 18 without the EMACs 28, and each EBA 18 may be configured to convert the brake control signals into a drive signal for the corresponding EBA 18.

In an embodiment, the drive signal for an individual EBA 18 drives a motor within the EBA 18 to position an actuator of the EBA. The motor may be driven to advance the actuator for the application of force to the brake stack 16 or to retract the actuator to reduce and/or cease the application of force to the brake stack 16.

The EMACs 28 in various embodiments receive power from a power bus. Two of the EMACs 28, such as a first EMAC 28a and a third EMAC 20c, may receive power from a first power bus 27a (for example, as referred to in FIG. 1 as DC1) of the aircraft to operate electronics in the respective EMACs 28 and to supply actuation signals to the EBAs 18. Similarly, the other two of the EMACs 28, such as a second EMAC 28b and a fourth EMAC 28d, may receive power from a second power bus 27b (for example, as referred to in FIG. 1 as DC2) of the aircraft to operate electronics in the respective EMACs 28 and to supply actuation signals to the EBAs 18. The power busses 27 each may supply, for example, 28 VDC to power the electronics and 270 VDC for use in generating the actuation drive signals.

In an embodiment, the brake control signals from the BCUs 20 are directed to EMACs 28 through a network of the aircraft. Signals may be exchanged between the BCUs 20 and the EMACs 28 through remote data concentrators (RDCs) 30. With continued reference to FIG. 1, two RDCs 30a and 30b are present so as to provide redundancy to the communications pathways. Primary communication links between the EMACs 28 and the RDCs 30 are shown in solid lines in FIG. 1 and secondary (e.g., backup) communication links between the EMACs 28 and RDCs 30 are shown in dotted lines in FIG. 1.

As noted above, the sensors 22 in various embodiments are used to sense various conditions associated with the braking system. The sensors 22 may be configured to communicate sensor data with the BCUs 20 via the RDCs 30. It should be understood that the illustrated data pathways are merely representative and that other configurations may be used. For instance, each sensor 22 may have an independent communication link with more than one RDC 30. Further, the sensors 22 may be configured to communicate with the EMACs 28, other EBAs 18, and/or directly with BCUs 20.

The braking system 10 may be configured to provide antiskid control to the wheels 12 to protect against braking failure due to a skid and/or sensor data loss. For example, even where data from wheel sensors becomes corrupted and/or unavailable, antiskid control may be employed to facilitate braking the aircraft. In various embodiments, the BCUs 20 may configured to execute an antiskid algorithm to facilitate antiskid control. For example, if the data from one or more of the wheel speed sensors 22 indicates that the wheel is not decelerating in a manner to avoid skidding of the aircraft and/or the wheel, the BCUs 20 may control the braking operation in an attempt to avoid skidding. For example, the BCUs 20 may reduce braking levels to facilitate avoiding wheel skidding.

In certain circumstances, if a wheel 12 undergoes rapid deceleration, it may be concluded that the wheel is about to skid. In this situation, the pressure applied the corresponding EBAs 18 may be reduced to facilitate restoring rotation of the wheel 12. Periodic reduction of applied pressure/force may be referred to as pulsing the applied pressure. In certain embodiments, the pressure may not be momentarily reduced, but may instead be reduced for a sufficient period to facilitate the braking of the aircraft and/or to restore rotation of a wheel. Further, various embodiments may be configured to prevent skids from becoming so sever that they result in a “lock up” of the wheel, but systems disclosed herein may also facilitate controlling the braking of an aircraft when a lock up has already occurred.

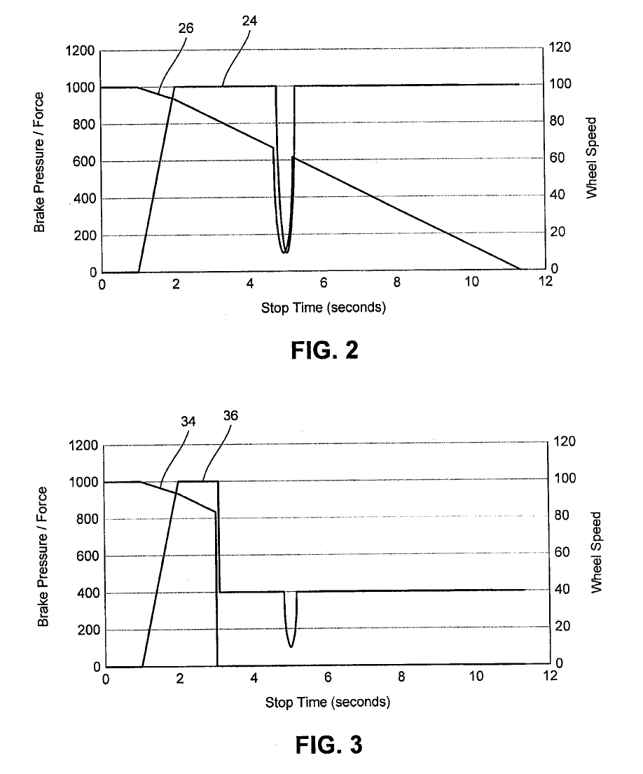

In that regard, and in accordance with an embodiment, FIG. 2 illustrates a graph showing brake pressure/force versus time overlaid with a graph of wheel speed information versus time for a wheel 12 with a functional wheel speed sensor 22 and a functional data path from the wheel speed sensor 22 to the BCU 20. In should be appreciated that the graph's scale is merely exemplary and for purposes of illustration, and the proportions, forces and scales may change, but still fall within the scope of this disclosure. The brake pressure/force versus time is shown by curve 24 and the wheel 12 speed information versus time is shown by curve 26. As braking is commanded, force is applied to the brake stack 16 up to a brake pressure/force level, which is approximately 1,000 units in the illustrated example. The normal brake pressure/force level may be dynamic based on sensed conditions and operational parameters. For example the “normal” brake pressure/force level may be an “operational” brake pressure/force level based on the brake pressure/force exerted on a wheel 12 prior to a loss of sensor data and/or prior to a skid condition beginning.

In response to the application of the brake pressure/force, the wheel 12 starts to decelerate. At one point, a rapid decline in sensed wheel speed may be detected, for example, where a skid occurs. In response, the BCU 20 may output signals to command the momentary reduction in brake pressure/force to allow the wheel 12 to resume rotation. When the wheel 12 starts to resume rotation, the force applied to brake stack 16 may be increased, such as to the normal and/or operational brake pressure/force limit and/or level. It should be understood that this increase to the normal and/or operational brake pressure/force level may be to a brake pressure/force level that is less than the level prior to the skid beginning. For example, the operational brake pressure/force level may be based on an aircraft and or wheel speed at the time rotation of the wheel is restored. Additionally, it should be understood that the operational brake pressure/force level may be based on any number of environmental and/or physical conditions of the aircraft or wheels at the time of braking. Furthermore, it should be understood that any reduction in brake pressure/force may not be momentary, but may last for a sufficient period to facilitate braking the aircraft and/or to restore rotation to a skidding wheel.

Where wheel speed data may become unavailable for one of the wheels 12, various embodiments provide methods for antiskid control. For example, FIG. 3 illustrates a graph that shows brake pressure/force versus time overlaid with a graph of wheel speed information versus time for a method according to an embodiment of compensating for unavailability of wheel speed sensor data for one of the wheels 12. Wheel speed data may still be available for one or more of the other wheels 12, and brake control over the wheels 12 for which data is available may proceed in accordance with the graph of FIG. 2.

Although various embodiments may be discussed herein with respect to wheel speed sensors, it should be understood that various other sensors may provide information relevant to antiskid protection. Where data from any such sensors may become unavailable, this unavailability may trigger the antiskid protection as disclosed with respect to the unavailability of speed sensor data.

In FIG. 3, the brake pressure/force versus time for a wheel 12 for which wheel speed data is not available is shown by curve 34 and the speed information versus time is shown by curve 36. In all of the following described embodiments, this wheel where data becomes unavailable will be referred to as an “affected wheel.” Wheel speed data may be considered not available for a variety of reasons, such as failure of the corresponding wheel speed sensor 22, failure of a data path to the BCU(s) 20, RDC(s) 30, and the like. Also, the unavailability of the wheel speed data may indicate a complete loss of a signal or the receipt of wheel speed data that is inconsistent with other information, such as wheel speed data from other sensors. A voting scheme, for example, comparing multiple wheel speed signals to determine a valid data range using simple logic, may be used to assess whether inconsistent wheel speed data is being received.

In accordance with an embodiment, and with continued reference to FIG. 3, as braking is commanded, force is applied to the brake stack 16 up to a normal brake pressure/force level. For example, up to 1,000 units of pressure/force, as illustrated in FIG. 3. The “normal” and/or “operational” pressure/force level is the pressure/force applied when wheel speed data is available to the BCU 20 for the wheel 12. That is, the normal pressure/force level is the operational braking pressure/force applied under circumstances where a sensor is operating correctly. In response to the force applied to the brake stack, the wheel 12 starts to decelerate. As noted above, the normal or operational pressure/force level may be based on any number of environmental or physical conditions associated with the aircraft at the time of braking, such as wheel condition, weather conditions, runway conditions, and the like.

FIG. 3 illustrates a scenario according to an embodiment where wheel speed data becomes unavailable for a wheel 12. Such data may become unavailable before, during, or after a braking operation. Where data is unavailable during a braking operation, the pressure/force level may be reduced from the normal and/or operational pressure/force level to a lower, modified force level. In an embodiment, a modified pressure/force level is used for the affected wheel such that the pressure/force level is reduced to a predetermined level versus the normal and/or operational level. In that regard, the modified level may be based on a percentage of the operating level prior to the data becoming unavailable (e.g., brake pressure/force applied prior to data loss based on environmental/operational/physical conditions), or the modified level may be based on a percentage of the operational level of wheels where speed data is still available, as discussed further below.

For example, as illustrated in FIG. 3, the modified level is about 400 units, or about 40 percent of the operational level at the time braking begins. It will be appreciated that the modified level may be some other percentage of the operational level prior to the data becoming unavailable, such as from about 850 units to about 400 units. In an embodiment, the modified level may be from about 20 percent to about 80 percent of the normal and/or operational level. Other percentages and/or ranges of percentages may be utilized to facilitate braking the aircraft in the absence of sensor data from a wheel. Such automatic reduction in braking pressure/force, in the absence of sensor data, is configured to reduce the chance that the wheel will begin skidding and/or to minimize the effects of a skidding wheel to facilitate braking the aircraft.

Where the wheel speed data is not available to the BCU 20 for a given wheel 12, some antiskid control may be conducted according to various embodiments. For example, when wheel speed data for another wheel 12 (e.g., one or more of the unaffected wheels that are providing sensor data to the BCU) indicates the presence of a possible skid condition (e.g., as illustrated in FIG. 2), the BCU 20 may control the braking of the affected wheel 12 by lowering the brake pressure/force that is applied to the affected wheel. This scenario is shown by way of example in FIG. 3 by the pulse in curve 36 that appears around the fifth second, which corresponds to the pulse in curve 24 of FIG. 2. In an embodiment, the BCU 20 may send the output command associated with the sensor input from the unaffected wheel and/or wheels to the EMAC and/or EBA associated with the affected wheel.

In an embodiment, the BCU 20 may treat the sensor input from the unaffected wheel and/or wheels as the sensor input from the affected wheel. For example, the BCUs 20 may use the minimum signal(s) of the wheel speed sensors 22 (e.g., the sensor that indicates the minimum velocity of the wheels 12) that continue to input data to the BCUs 20 as the wheel speed signal for the affected wheel 12. The BCUs 20 may further use signal(s) of the wheel speed sensor(s) 22 for the wheel(s) 12 that are most dynamically similar to the affected wheel, for example, a wheel and/or wheels on the same gear and in the same position as the affected wheel. In this manner, the antiskid processor of the BCU 20 may continue to carry out antiskid operations for the affected wheel in a conservative control mode.

An embodiment as illustrated in FIG. 3 uses a modified and/or fixed pressure/force level for the affected wheel to avoid conditions that may lead to skidding and potential tire burst, but in an environment where the wheel speed of the affected wheel is not directly sensed. The modified pressure/force level is set to optimize total braking while attempting to avoid this potentially unsafe condition. Therefore, in an embodiment as illustrated in FIG. 3, the wheel without available wheel speed data is commanded using the modified pressure/force level and with commanded braking control (e.g., deceleration, antiskid, force, and pressure control) as based on the wheel speed data from and/or BCU output commands associated with one or more of the unaffected wheels 12. In an embodiment, braking of the affected wheel is controlled with the commands that follow from the minimum (e.g., lowest) pressure/force level and commanded brake control that is determined from other wheels and/or combinations of wheels, such as those that are dynamically similar to the affected wheels.

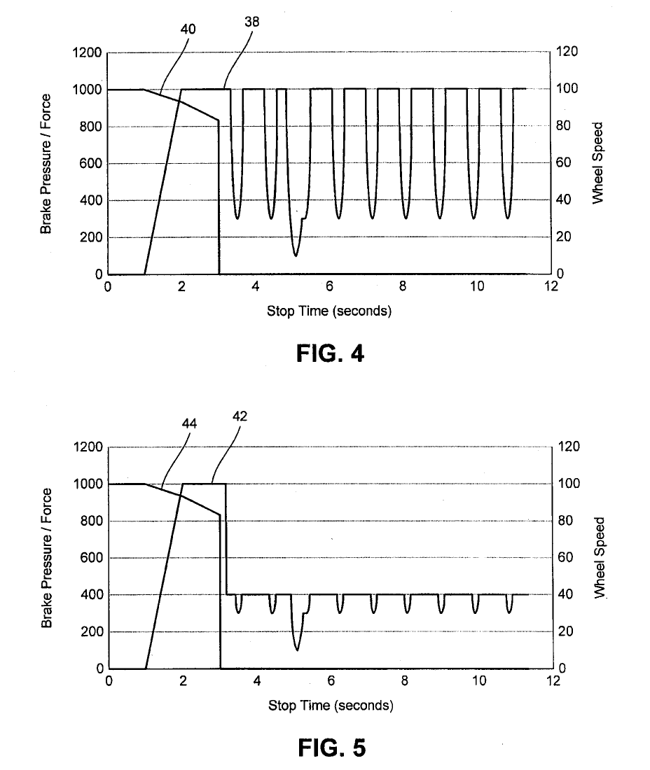

Further, in accordance with an embodiment as illustrated in FIG. 4, a graph shows brake pressure/force versus time overlaid with a graph of wheel speed information versus time for another technique of compensating for unavailability of wheel speed sensor data for one of the wheels 12. Wheel speed data may still be available for one or more of the other wheels 12, and brake control over the wheels 12 for which data is available may proceed, as discussed above with respect to FIG. 2.

In an embodiment as illustrated in FIG. 4, the brake pressure/force versus time for the affected wheel 12 is shown by curve 38 and the speed information versus time is shown by curve 40. As braking is commanded, force is applied to the brake stack 16 up to a normal brake pressure/force level, for example, 1,000 units. The normal pressure/force level is the brake pressure/force applied when wheel speed data is available to the BCU 20 for the wheel 12.

In response to the applied brake pressure/force, the wheel 12 starts to decelerate. In response to wheel speed data becoming unavailable, the normal pressure/force level may be maintained, but the applied pressure/force is pulsed on a periodic basis during the unavailability of the speed data. In such an embodiment, a brake and release approach is used for the affected wheel where the pressure/force is periodically reduced to a predetermined level. In the illustrated example of FIG. 4, the momentary reduction for each period may be a reduction in pressure/force to about 30 percent of the normal pressure/force level over a time of approximately 0.1 to 0.7 seconds. It will be appreciated that the reduction may be a reduction to another percentage, such as about 10 percent to about 80 percent of the operational level. Further, in accordance with various embodiments, the time of the pressure/force reduction may be longer or shorter than illustrated in FIG. 4 to facilitate avoiding a skid condition of the affected wheel. The duration of the pressure/force reductions may be short enough to avoid a tire burst, but may be long enough so as not to excite undesired dynamics such as gear walk.

In various embodiments where the wheel speed data is not available to the BCU 20, some antiskid control may be conducted. For example, when wheel speed data for another wheel 12 (e.g., one or more of the unaffected wheels) indicates the presence of a possible skid condition (e.g., as illustrated in FIG. 2), the BCU 20 may control the braking of the affected wheel 12 by lowering the brake pressure/force that is applied to the affected wheel. Such control may occur by using a BCU output command associated with an unaffected wheel, or by using sensor input to the BCU from an unaffected wheel in place of the sensor input from the affected wheel. For example, this reduction is illustrated in FIG. 4 by the pulse in curve 38 that appears around the fifth second, which corresponds to the pulse in curve 24 of FIG. 2. The antiskid pulse in curve 38 overlaps with one of the periodic pulses. In an embodiment, if an antiskid pulse is made in response to a skid condition of an unaffected wheel, the next scheduled periodic pulse for the affected wheel may be omitted or delayed so as to avoid overlapping of an antiskid pulse and a periodic pulse. As noted above, the pulse period may be adjusted so as to be short enough to avoid tire bursting and long enough to avoid exciting aircraft dynamics such as gear walk.

In an embodiment as illustrated in FIG. 4, the BCUs 20 may use the minimum speed signal(s) of the wheel speed sensors 22 that continue to input data to the BCUs 20 as the wheel speed signal for the affected wheel 12. The BCUs 20 may further use signal(s) of the wheel speed sensors 22 for the wheels 12 that are most dynamically similar to the affected wheel, for example, a wheel on the same gear and in the same position as the affected wheel. In this manner, the antiskid processor of the BCU 20 may continue to carry out antiskid operations for the affected wheel in a conservative control mode. For example, a technique as illustrated in FIG. 4 uses a periodic reduction in pressure/force for the affected wheel to avoid conditions that may lead to skidding and potential tire burst, but in an environment where the wheel speed of the affected wheel is not directly sensed. The modified application pressure/force is implemented to optimize total braking while attempting to avoid this potentially unsafe condition. In an embodiment such as that illustrated in FIG. 4, the wheel without available wheel speed data is commanded using periodic pulsing and with commanded braking control (e.g., deceleration, antiskid and pressure control) based on the wheel speed data from and/or BCU output commands from the BCU 20 associated with one or more of the unaffected wheels 12. In an embodiment, braking of the affected wheel is controlled with the commands that follow from the minimum (e.g., lowest) pressure/force level and commanded brake control that is associated with another of the wheels 12.

With reference now to FIG. 5, a graph showing brake pressure/force versus time overlaid with a graph of wheel speed information versus time for an embodiment that is configured to compensate for unavailability of wheel speed sensor data for one of the wheels 12. Wheel speed data may still be available for one or more of the other wheels 12, and brake control over the wheels 12 for which data is available may proceed in accordance with the graph of FIG. 2.

As illustrated in FIG. 5, the brake pressure/force versus time for the affected wheel 12 is shown by curve 42 and the speed information versus time is shown by curve 44. As braking is commanded, force is applied to the brake stack 16 up to a normal brake pressure/force level, for example, 1,000 units. The normal pressure/force level is the pressure/force applied to a wheel 12 when wheel speed data is available to the BCU 20 for the wheel 12.

In response to the applied pressure/force, the wheel 12 starts to decelerate. In response to wheel speed data becoming unavailable (at some point of the braking operation), the normal pressure/force level may be reduced in the manner described in connection with FIG. 3 and the amount of pressure/force may be pulsed as described in connection with FIG. 4 during the unavailability of the wheel speed data. The duration of the pressure/force reductions may be short enough to avoid a tire burst, but may be long enough so as not to excite undesired dynamics such as gear walk. An embodiment as illustrated in FIG. 5 may comprise a combination of the embodiments as illustrated in FIGS. 3 and 4.

Where the wheel speed data is not available to the BCU 20, some antiskid control may be conducted in accordance with various embodiments. For example, when wheel speed data for another wheel 12 (e.g., one or more of the unaffected wheels) indicates the presence of a possible skid condition (e.g., as illustrated in FIG. 2), the BCU 20 may control the braking of the affected wheel 12 by momentarily lowering the brake pressure/force that is applied to the wheel. This scenario is shown by way of example in FIG. 5 by the pulse in curve 42 that appears around the fifth second, which corresponds to the pulse in curve 24 of FIG. 2.

In an embodiment as illustrated in FIG. 5, the BCUs 20 may use the minimum signal(s) of the wheel speed sensors 22 that continue to input data to the BCUs 20 as the wheel speed signal for the affected wheel 12. The BCUs 20 may further use signal(s) of the wheel speed sensors 22 for the wheels 12 that are most dynamically similar to the affected wheel, for example, a wheel on the same gear and in the same position as the affected wheel. In this manner, the antiskid processor of the BCU 20 may continue to carry out antiskid operations for the affected wheel in a conservative control mode. For example, the technique as illustrated in FIG. 5 uses a reduction in the pressure/force level and a periodic reduction in pressure/force (e.g., pulsing) to avoid conditions that may lead to skidding and potential tire burst, but in an environment where the wheel speed of the affected wheel is not directly sensed. The modified application of pressure/force is implemented to optimize total braking while attempting to avoid this potentially unsafe condition.

In an embodiment as illustrated in FIG. 5, the wheel without available wheel speed data is commanded using periodic pulsing, a modified pressure/force level, and/or with commanded braking control (e.g., deceleration, antiskid and pressure control) based on the wheel speed data from and/or BCU 20 output commands associated with one or more of the unaffected wheels 12. In an embodiment, braking of the affected wheel is controlled with the commands from the BCU 20 that follow from the minimum (e.g., lowest) pressure/force level and commanded brake control that is determined for another of the wheels where speed data is available. The BCUs 20 may further use signal(s) of the wheel speed sensors 22 for the wheels 12 that are most dynamically similar to the affected wheel, for example, a wheel on the same gear and in the same position as the affected wheel

Although the invention has been shown and described with respect to certain embodiments, equivalents and modifications will occur to others who are skilled in the art upon reading and understanding of the specification. Various embodiments include all such equivalents and modifications, and are limited only by the scope of the following claims.

Additionally, benefits, other advantages, and solutions to problems have been described herein with regard to various embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for braking a vehicle, comprising:
receiving an input brake command that indicates a desired amount of braking for the vehicle;
deriving a brake control signal from the input brake command to facilitate applying a braking force to a wheel of the vehicle, wherein the braking force facilitates achieving the desired amount of braking for the vehicle;
determining that data from a sensor associated with the wheel is unavailable; and
modifying the brake control signal in response to the determining that the data is unavailable to facilitate the desired amount of braking for the vehicle.

2. The method of claim 1, wherein the input brake command is associated with an amount of depression of a brake pedal in the vehicle.

3. The method of claim 1, further comprising instructing an electromechanical brake actuator (EBA) to apply the braking force to the wheel.

4. The method of claim 3, wherein the instructing the EBA includes transmitting the brake control signal to an electromechanical actuator controller (EMAC) configured to convert the brake control signal into a drive signal specific to the EBA to facilitate applying the braking force to the wheel.

5. The method of claim 3, wherein the determining that the data from the sensor is unavailable is in response to the EBA applying the braking force to the wheel.

6. The method of claim 1, wherein the sensor is a wheel speed sensor, and wherein a sensed speed of the wheel indicates a skid condition of the wheel.

7. The method of claim 1, wherein the modifying the brake control signal includes indicating a reduced braking force to facilitate avoiding a skid condition of the wheel in response to the data from the sensor being unavailable.

8. The method of claim 7, wherein the reduced braking force is a percentage of the braking force between approximately 20 percent and approximately 80 percent of the braking force.

9. The method of claim 1, further comprising deriving a second brake control signal from the input brake command to facilitate applying a second braking force to a second wheel of the vehicle, wherein the brake control signal includes a first brake control signal, wherein the braking force includes a first braking force, wherein the wheel includes a first wheel of the vehicle, wherein the data from the sensor includes first data from a first sensor, and wherein the first braking force and the second braking force facilitate achieving the desired amount of braking for the vehicle.

10. The method of claim 9, further comprising receiving second data from a second sensor associated with the second wheel.

11. The method of claim 10, further comprising reducing the second braking force to a modified second braking force in response to the second data indicating that the second wheel is skidding.

12. The method of claim 9, further comprising reducing the first braking force in response to the reducing the second braking force, wherein the first braking force is reduced to be substantially the same as the modified second braking force.

13. The method of claim 11, further comprising substituting the second data for the first data in response to the first data being unavailable, and using the second data to determine the first brake control signal.

14. The method of claim 10, further comprising using the second data to generate the second brake control signal, wherein the modifying the first brake control signal includes replacing the first brake control signal with the second brake control signal in response to the first data from the first sensor being unavailable.

15. The method of claim 1, wherein the modifying the brake control signal facilitates periodically pulsing the braking force to facilitate avoiding a skid condition of the wheel.

16. A method for braking a vehicle, comprising:
receiving an input brake command that indicates a desired amount of braking for the vehicle;
deriving a first brake control signal from the input brake command to facilitate applying a first braking force to a first wheel of the vehicle, wherein the first braking force facilitates achieving the desired amount of braking for the vehicle;
determining that first data from a first sensor associated with the first wheel is unavailable; and
modifying the first brake control signal based upon information associated with a second wheel in response to the determining that the first data is unavailable, to facilitate the desired amount of braking for the vehicle.

17. The method of claim 16, wherein the information associated with the second wheel includes second data from a second sensor associated with the second wheel.

18. The method of claim 17, further comprising deriving a second brake control signal from the input brake command and the second data from the second sensor, wherein the modifying the first brake control signal includes substituting the first brake control signal with the second brake control signal in response to the determining that the first data is unavailable.

19. The method of claim 17, wherein the deriving the first brake control signal includes deriving the first brake control signal from the input brake command and the first data from the first sensor, and wherein the modifying the first brake control signal includes modifying the first brake control signal based upon at least one of the second data from the second sensor and third data from a third sensor associated with a third wheel in response to the determining that the first data is unavailable.

20. A brake system, comprising:
a controller configured to receive an input brake command that indicates a desired amount of braking for a vehicle, and to derive a first brake control signal from the input brake command to facilitate applying a first braking force to a first wheel of the vehicle, wherein the first braking force facilitates achieving the desired amount of braking for the vehicle; and
a first sensor associated with the first wheel, wherein the controller is configured to determine that first data from the first sensor is unavailable, and wherein the controller is configured to modify the first brake control signal based upon information associated with a second wheel in response to the determining that the first data is unavailable, to facilitate the desired amount of braking for the vehicle.
